(19) United States
(12) Patent Application Publication
(10) Pub. No.: US 2026/0109540 A1
(43) Pub. Date: Apr. 23, 2026

(54) REFUSE VEHICLE WITH ENVIRONMENTAL DETECTION SYSTEM

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Oshkosh, WI (US); Johnny Bui, Oshkosh, WI (US); Nagabhushana Sharma Gurumurthy, Oshkosh, WI (US); Monika Nagalla, Oshkosh, WI (US); John Zucca, Oshkosh, WI (US)

(73) Assignee: Oshkosh Corporation, Oshkosh, WI (US)

(21) Appl. No.: 18/919,192

(22) Filed: Oct. 17, 2024

Related U.S. Application Data
(60) Provisional application No. 63/593,769, filed on Oct. 27, 2023.

(51) Int. Cl. B65F 3/02

(52) U.S. Cl. CPC B65F 3/02; B65F 2003/025; B65F 2003/0279

(57) ABSTRACT

A refuse vehicle includes a lift apparatus, an electromagnetic radiation (EMR) detector, a distance sensor, a camera, and processing circuitry. The lift apparatus includes forks configured to be received within pockets of a refuse container. The EMR detector detects a presence of a power line overhead of the refuse vehicle. The distance sensor detects a distance of an obstacle that is overhead of the refuse vehicle. The camera obtains image data of the obstacle that is overhead of the refuse vehicle. The processing circuitry obtains feedback from the EMR detector, the distance sensor, and the camera and determines, based on the feedback, whether an obstacle is present within a threshold distance above the refuse vehicle. The processing circuitry prevents operation of the lift apparatus responsive to determining that the obstacle is present within the threshold distance above the refuse vehicle.

### CROSS-REFERENCE TO RELATED PATENT APPLICATION

This application claims the benefit of and priority to U.S. Provisional Application No. 63/593,769, filed Oct. 27, 2023, the entire disclosure of which is incorporated by reference herein.

### BACKGROUND

The present disclosure generally relates to the field of refuse vehicles. More specifically, the present disclosure relates to control systems for refuse vehicles.

### SUMMARY

One embodiment of the present disclosure relates to a refuse vehicle. The refuse vehicle may include a lift apparatus, an electromagnetic radiation (EMR) detector, a distance sensor, a camera, and processing circuitry. The lift apparatus can include forks configured to be received within pockets of a refuse container and lift and empty contents of the refuse container into a hopper of the refuse vehicle. The EMR detector can be configured to detect a presence of a power line overhead of the refuse vehicle. The distance sensor can be configured to detect a distance of an obstacle that is overhead of the refuse vehicle. The camera can be configured to obtain image data of the obstacle that is overhead of the refuse vehicle. The processing circuitry can be configured to obtain feedback from the EMR detector, the distance sensor, and the camera. The processing circuitry can further be configured to determine, based on the feedback, whether an obstacle is present within a threshold distance above the refuse vehicle. The processing circuitry can further be configured to prevent operation of the lift apparatus responsive to determining that the obstacle is present within the threshold distance above the refuse vehicle.

Another embodiment of the present disclosure relates to a refuse vehicle. The refuse vehicle may include a lift apparatus, an outwards facing camera, and processing circuitry. The lift apparatus may include forks configured to be received within pockets of a refuse container and lift and empty contents of the refuse container into a hopper of the refuse vehicle. The outwards facing camera can be configured to obtain image data of an area proximate the refuse vehicle. The processing circuitry can be configured to detect, based on the image data, a presence, location, and orientation of a refuse container. The processing circuitry can also be configured to determine, based on the presence, location, and orientation of the refuse container, a path for transportation of the refuse vehicle such that transportation of the refuse vehicle along the path results in the forks of the lift apparatus being properly aligned with and inserted into the pockets of the refuse container. The processing circuitry can also be configured to at least one of (i) autonomously operate the refuse vehicle to transport along the path, or (ii) operate a display screen to provide the image data with a visual indication of the path superimposed over the image data.

Yet another embodiment of the present disclosure relates to a method of controlling operation of a refuse vehicle. The method includes obtaining sensor data of a site from a sensor. The method includes determining a profile of the site including an obstacle map using the sensor data. The method includes autonomously control the refuse vehicle based on the obstacle map such that the refuse vehicle avoids obstacles while transporting and operating a lift apparatus at the site.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIG. 1-3, according to an exemplary embodiment;

FIG. 5 is a diagram illustrating a collection route for autonomous transport and collection by any of the refuse vehicles of FIG. 1-3, according to an exemplary embodiment;

FIG. 6 is a perspective view of the refuse vehicle of FIG. 1 equipped with an awareness system configured to detect overhead obstacles, according to an exemplary embodiment.

FIG. 7 is a side view of the awareness system of FIG. 6 configured to detect different types of overhead obstacles, according to an exemplary embodiment.

FIG. 8 is a block diagram of the awareness system of FIG. 6, according to an exemplary embodiment.

FIG. 9 is a block diagram of a controller of the awareness system of FIG. 6, according to an exemplary embodiment.

FIG. 10 is a top view of a portion of the refuse vehicle equipped with the awareness system of FIG. 6, according to an exemplary embodiment.

FIG. 11 is a flow diagram of a process for autonomously controlling a refuse vehicle based on detected overhead obstacles, according to an exemplary embodiment.

FIG. 12 is a flow diagram of a process for limiting operation of a lift assembly of a refuse vehicle based on detected overhead obstacles, according to an exemplary embodiment.

FIGS. 13-16 are diagrams illustrating a path for autonomous refuse collection determined by the awareness system of FIG. 6, according to an exemplary embodiment.

FIG. 17 is a perspective view of the refuse vehicle equipped with the awareness system of FIG. 6 including a front facing camera, according to an exemplary embodiment.

FIG. 18 is a side view of a refuse container including pockets, according to an exemplary embodiment.

FIG. 19 is a block diagram of the controller of the awareness system of FIG. 6 configured to detect the presence of nearby refuse containers and determine a route to the nearby refuse containers, according to an exemplary embodiment.

FIG. 20 is a graphical user interface illustrating a superimposed path to a refuse container, according to an exemplary embodiment.

FIG. 21 is a flow diagram of a process for guiding a refuse vehicle along a route to a nearby refuse container for pickup, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a refuse vehicle includes an awareness system that is configured to detect different types of overhead obstacles. For example, the awareness system can be configured to detect powerlines, tree branches, overhangs, etc. The awareness system may limit operation of a lift apparatus of a front end loading refuse vehicle. The awareness system can also include externally mounted or outwards facing cameras configured to obtain image data. The image data can be analyzed to identify nearby refuse containers and determine a path to approach and insert forks of the lift apparatus into pockets of the refuse containers. The awareness system may autonomously operate the refuse vehicle along the path or may operate a display screen to prompt an operator to transport the refuse vehicle along the path.

### Refuse Vehicle

### Front-Loading Configuration

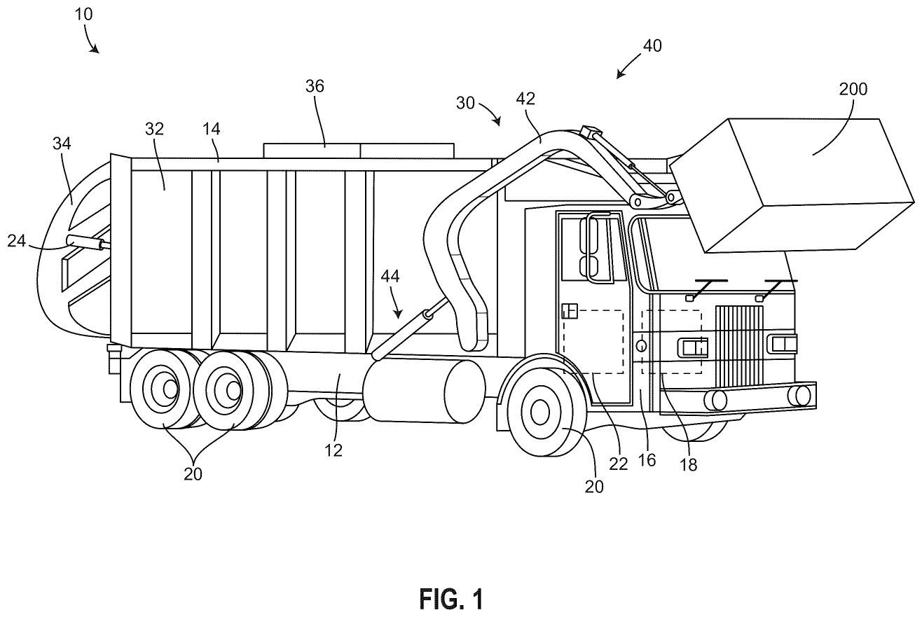

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42.

The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-Loading Configuration

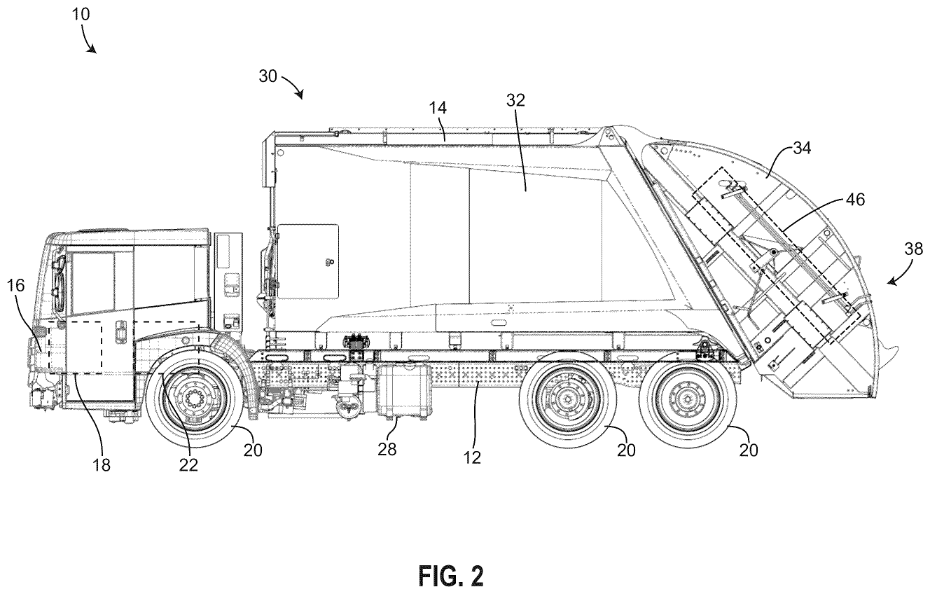

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

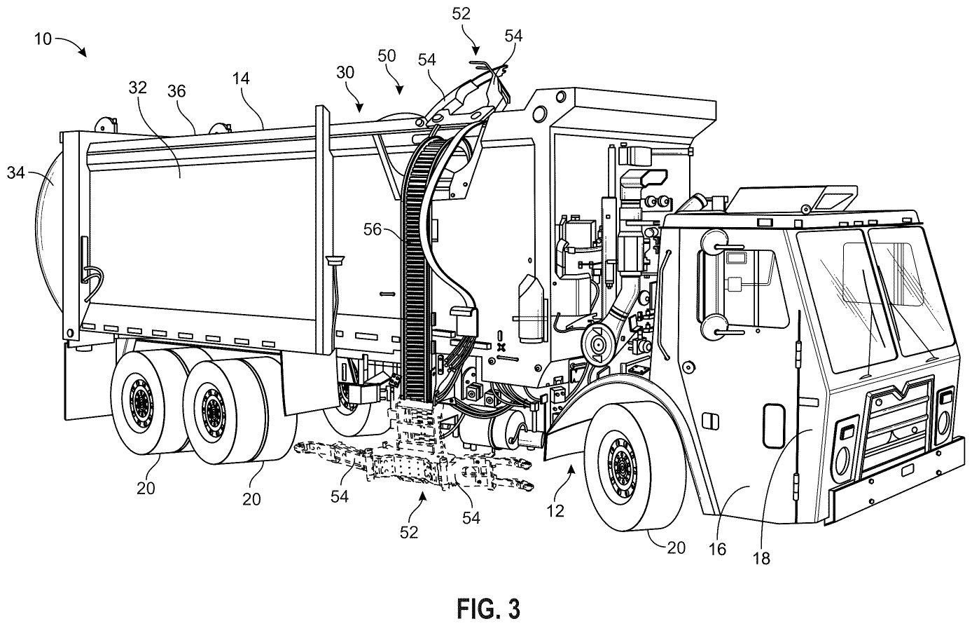

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

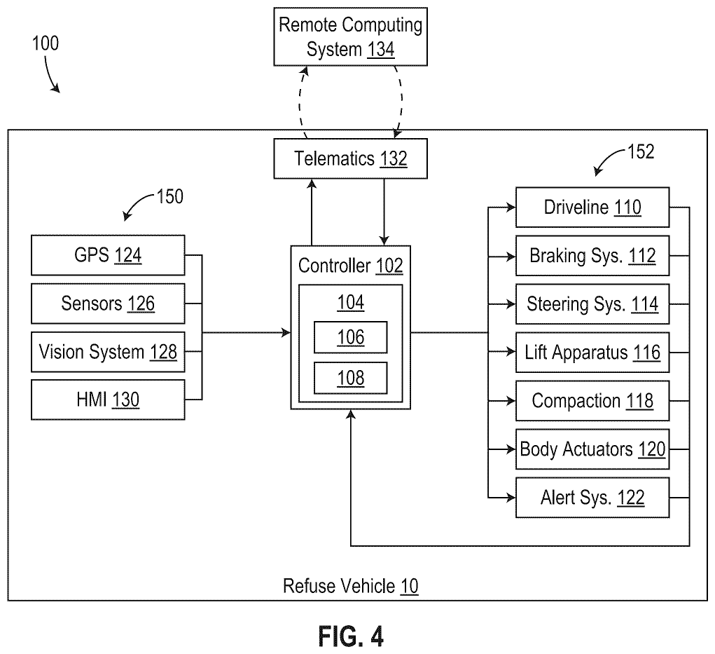

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

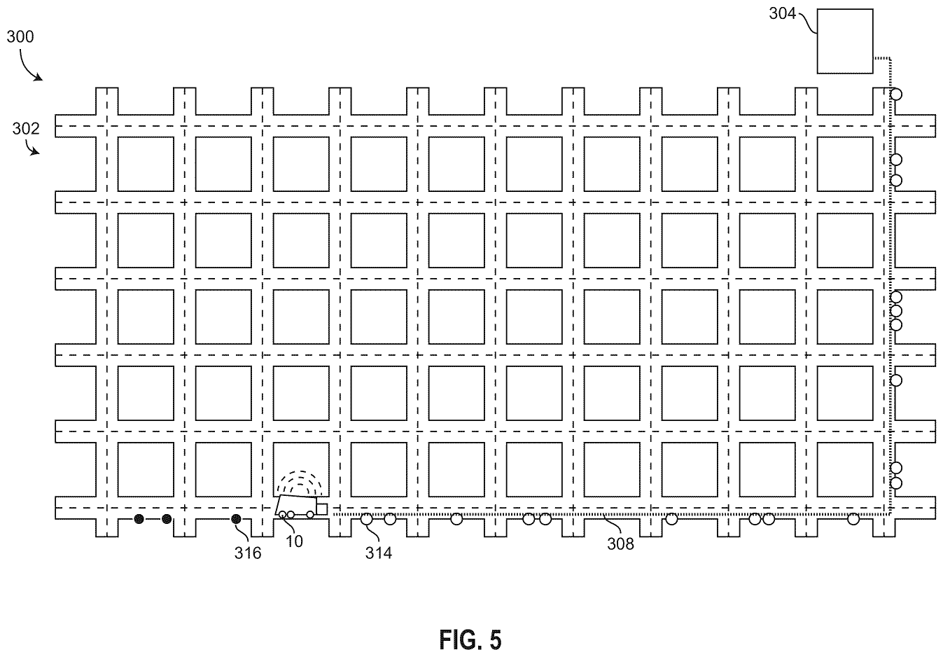

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Environmental Detection System

### Overhead Obstacle Detection

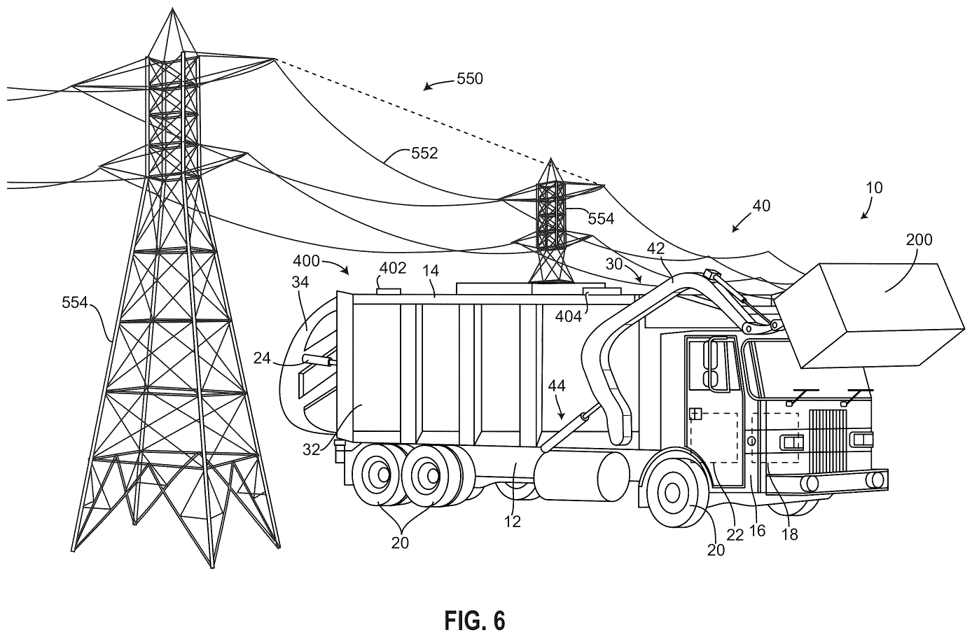

Referring to FIG. 6, the refuse vehicle 10 includes an awareness system 400 (e.g., a detection system, a vision system, an environmental detection system, an environmental awareness system, etc.) that is configured to detect overhead objects, obstacles, obstructions, etc. The awareness system 400 may be configured to detect different types of objects such as tree limbs, power lines, fire escapes, building overhangs, telephone poles, overpasses, signs, billboards, street lights, or any other object that may be above the refuse vehicle 10. The awareness system 400 may use a variety of sensors, detectors, emitters, detection sub-systems, etc., to detect different types of objects. For example, objects such as powerlines, telephone lines, cable lines, etc., may be difficult to detect by a vision or Light Detection and Ranging (“LiDAR”) system due to their small size. However, power lines or electrically conducting elements (e.g., cables) may be detected by their electromagnetic radiation signature.

As shown in FIG. 6, the awareness system 400 includes an electromagnetic radiation (“EMR”) detector 402 configured to detect the presence of particular EMRs. The EMR detector 402 is configured to detect power lines 552 based on their EMR signature or EMR output (e.g., their electromagnetic frequency). For example, as shown in FIG. 6, the vehicle 10 is positioned beneath the power lines 552 proximate poles 554 of a power transmission system 550. When the refuse vehicle 10 performs collection in residential environments, the refuse vehicle 10 may frequently encounter overhead power lines 552 at pickup locations (e.g., power lines going to a house, residency, or nearby building at which the refuse vehicle 10 is picking up the refuse container 200. The EMR detector 402 is configured to measure or detect EMR signatures of the power lines 552 to identify locations at which the power lines 552 extend. The EMR detector 402 may be a low frequency EMR detector. The EMR detector 402 may be configured to measure electromagnetic frequency that is less than 300 Hz. In some embodiments, the EMR detector 402 is configured to detect extremely low frequencies such as 50 Hz or 60 Hz that are emitted by power lines 552 that transmit alternating current (AC) electrical power. The EMR detector 402 may also be configured to detect a strength of intensity of the

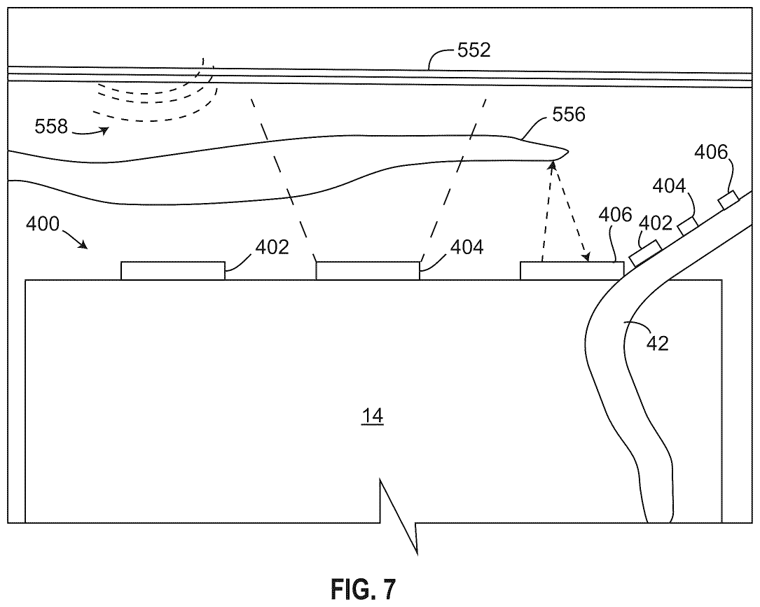

Referring to FIG. 7, the EMR detector 402 is configured to detect the presence and intensity of extremely low (e.g., less than 300 Hz) electromagnetic fields 558 that may be emitted by power lines 552. The EMR detector 402 may be configured to detect both the presence and the intensity (e.g., strength) of the electromagnetic fields in order to determine a relative distance between the refuse vehicle 10 and the power lines 552. The EMR detector 402 may be positioned on top of the refuse vehicle 10 (e.g., on top of the body 14) such that the EMR detector 402 is configured to detect overhead power lines 552. The EMR detector 402 advantageously facilitates identifying both the presence and relative distance of overhead power lines 552 which may otherwise be difficult to detect via the camera 404 or the LiDAR sensor 406.

Referring still to FIG. 7, the camera 404 and the LiDAR sensor 406 can be configured to detect the presence of objects 556 (e.g., tree branches, light poles, physical objects, etc.). The objects 556 may be overheard objects or obstacles that do not necessarily emit electromagnetic radiation. The camera 404 and the LiDAR sensor 406 may similarly be disposed on the top of the refuse vehicle 10 such that the camera 404 is configured to obtain image data of an area or space above the refuse vehicle 10 and the LiDAR sensor 406 is configured to detect objects (e.g., using time of flight analysis) and relative distance of the objects above the refuse vehicle 10. The EMR detector 402, the camera 404, and the LiDAR sensor 406 may alternatively or additionally be positioned on the lift arms 42 of the refuse vehicle 10. If the EMR detector 402, the camera 404, or the LiDAR sensor 406 are disposed on the lift arms 42, feedback (e.g., data, information, signals, etc.) may be assessed while accounting for the current position or orientation of the lift arms 42.

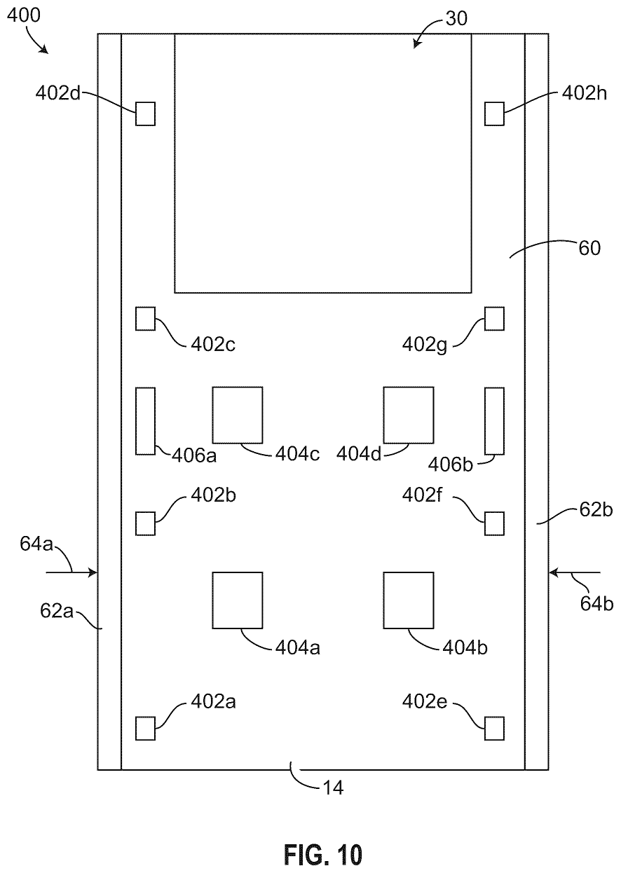

Referring now to FIG. 10, the awareness system 400 may include one or more arrays of multiple EMR detector 402. As shown in FIG. 10, the vehicle 10 includes a first array of EMR detectors, shown as EMR detector 402a, EMR detector 402b, EMR detector 402c, and EMR detector 402d. The first array of EMR detectors 402 may be positioned centrally along the top of the refuse vehicle 10, along a side of the refuse vehicle 10, or along any other upper portion of the refuse vehicle 10 such that the EMR detectors 402 are configured to detect the presence of electromagnetic radiation (e.g., at extremely low frequencies such as less than 300 Hz) at multiple locations either longitudinally or laterally along the refuse vehicle 10.

Referring still to FIG. 10, the awareness system 400 may include a second array of EMR detectors, shown as EMR detector 402e, EMR detector 402f, EMR detector 402g, and EMR detector 402h. The second array of EMR detectors may be laterally spaced relative to the first array of EMR detectors so that the second array of EMR detectors are configured to detect power lines 552 at a lateral side of the refuse vehicle 10 opposite the lateral side at the first array. The awareness system 400 may also include a first LiDAR sensor 406a and a second LiDAR sensor 406b that are disposed on opposite lateral sides of the refuse vehicle 10. The awareness system 400 may also include multiple cameras, shown as camera 404a, camera 404b, camera 404c, and camera 404d.

Referring to FIG. 10, the EMR detectors 402, the cameras 404, and the LiDAR detectors 406 may be disposed on a top surface 60 of the body 14. Any of the EMR detectors 402, the cameras 404, or the LiDAR detectors 406 may be disposed on lateral sides 64 of the refuse vehicle 10. For example, the first array of EMR detectors may be disposed on a first lateral side 64a (e.g., a street-side) of the body 14 of the refuse vehicle. Likewise, the second array of EMR detectors may be disposed on a second lateral side 64b such that the second array of EMR detectors are configured to detect power lines 552 at an opposite side (e.g., a curb-side) of the body 14 of the refuse vehicle 10. Any of the EMR detectors 402, the cameras 404, or the LiDAR detectors 406 may be disposed along a rail 62a or a rail 62b that extends along either side of the body 14 of the refuse vehicle 10.

It should be understood that the positioning and arrangement of the EMR detectors 402, the cameras 404, and the LiDAR detectors 406 as described herein with reference to FIG. 10 is illustrative only and is not intended to be limiting. For example, any of the EMR detectors 402, the cameras 404, or the LiDAR detectors 406 may be disposed on a top of the cab 16 such that the EMR detectors 402, the cameras 404, or the LiDAR detectors 406 are configured to detect the presence and relative distance or position of overhead objects, obstacles, etc., proximate the lift assembly 40.

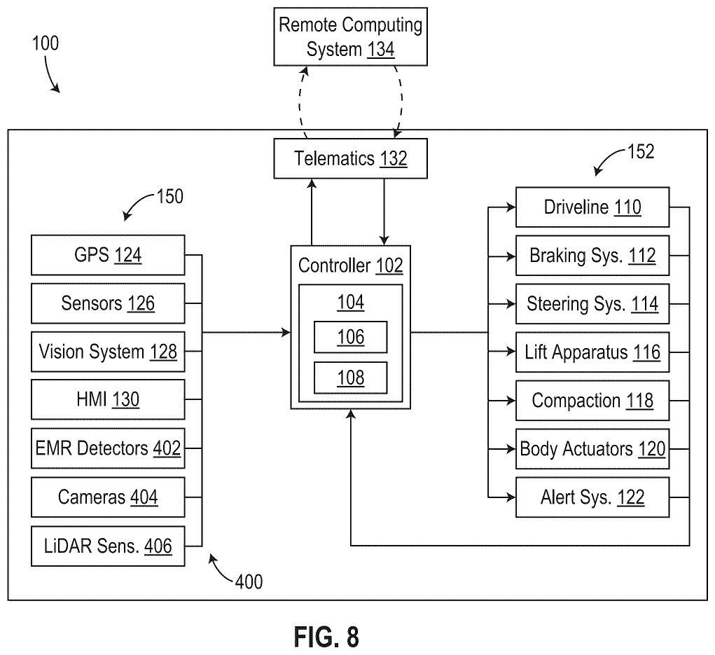

Referring to FIG. 8, the controller 102 may be configured to receive data from the EMR detectors 402, the cameras 404, and the LiDAR sensors 406 and use the data to operate the alert system 122 or the lift apparatus 116. The controller 102 may also use the data provided by the awareness system 400 in order to limit operation of the lift apparatus 116 if the data provided by the awareness system 400 indicates that operation of the lift apparatus 116 (e.g., the lift assembly 40) would result in contacting an overhead object. The controller 102 may also use the data provided by the awareness system 400 (e.g., in real-time) to operate at least one of the braking system 112, the steering system 114, or the driveline 110 in order to transport the refuse vehicle 10 to a location or position such that the lift apparatus 116 can be operated without contacting overhead objects (e.g., to maintain a safe distance between the lift apparatus 116 and the overhead objects).

The controller 102 may communicate with the remote computing system 134 via the telematics 132. The controller 102 may upload any of the data obtained from the GPS 124, the awareness system 400, etc., to the remote computing system 134 and receive instructions from the remote computing system 134 (e.g., an obstacle map for a location). The controller 102 may use the instructions in combination with the data from the awareness system 400 in order to operate the driveline 110, the braking system 112, and the steering system 114 to autonomously transport the refuse vehicle 10 to a location at which the lift apparatus 116 is not obstructed by overhead obstacles.

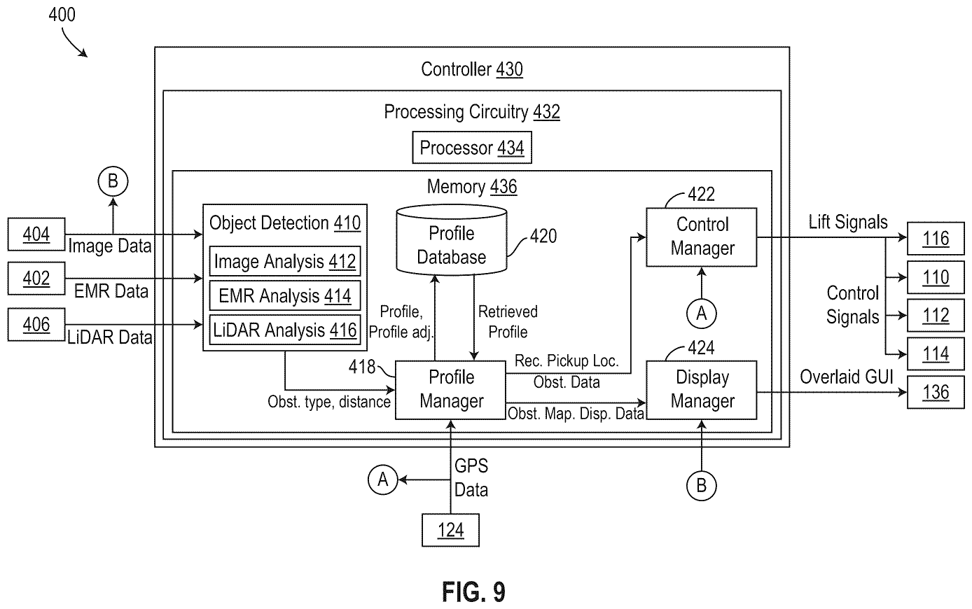

Referring to FIG. 9, a controller 430 is configured to receive the image data from the cameras 404, the EMR data from the EMR detector 402, and the LiDAR data from the LiDAR sensor 406. The controller 430 includes processing circuitry 432 including a processor 434 and memory 436. Processing circuitry 432 can be communicably connected with a communications interface of controller 430 such that processing circuitry 432 and the various components thereof can send and receive data via the communications interface. Processor 434 can be implemented as a general purpose processor, an application specific integrated circuit (ASIC), one or more field programmable gate arrays (FPGAs), a group of processing components, or other suitable electronic processing components.

Memory 436 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 436 can be or include volatile memory or non-volatile memory. Memory 436 can include database components, object code components, script components, or any other type of information structure for supporting the various activities and information structures described in the present application. According to some embodiments, memory 436 is communicably connected to processor 434 via processing circuitry 432 and includes computer code for executing (e.g., by at least one of processing circuitry 432 or processor 434) one or more processes described herein.

The memory 436 includes an object detection manager 410 that is configured to receive the image data, the EMR data, and the LiDAR data and detect an object using any of or any combination of the image data, the EMR data, and the LiDAR data. The object detection manager 410 may be configured determine both a type of the object and a distance of the object relative to a top of the refuse vehicle 10. For example, the object detection manager 410 may be configured to perform various analyses based on each of the image data, the EMR data, and the LiDAR data in order to determine the type of object or obstacle and to identify position (e.g., distance) of the object or obstacle. The object detection manager 410 is configured to implement an image analysis technique 412, an EMR analysis technique 414, and a LiDAR analysis technique 416.

The image analysis technique 412 can include implementing image recognition technology (e.g., a neural network, machine learning, artificial intelligence, etc.) to detect types of objects or obstacles that are overhead of the refuse vehicle 10. The image analysis technique 412 may use a database of predetermined objects and labels (e.g., tree branches, fire escapes, signs, beams, power lines, etc., or any other objects that may be commonly encountered above the refuse vehicle 10). The image analysis technique 412 may be implemented in order to determine the type of obstacle. In some embodiments, the image analysis technique 412 is also configured to estimate the distance between the refuse vehicle 10 (e.g., the top of the body 14) and the obstacle. For example, if the awareness system 400 includes multiple cameras 404, the object detection manager 410 may use a comparison between the multiple cameras 404 having different perspectives to identify an estimated distance between the refuse vehicle 10 and the object or obstacle.

The EMR analysis technique 414 is configured to use the EMR data and determine, based on the EMR data, whether a power line is overhead the vehicle 10. In some embodiments, the EMR analysis technique 414 includes identifying a presence of a particular frequency of EMR fields or waves (e.g., less than 300 Hz) corresponding to EMR frequency emitted by power lines. The EMR analysis technique 414 can also include using an intensity (e.g., a strength, a magnitude, etc.) of the EMR data in order to estimate a distance between the refuse vehicle 10 (e.g., the top of the body 14) and the power lines. In some embodiments, the EMR analysis technique 414 includes using the EMR data from multiple or arrays of EMR detectors 402 and implementing a triangulation technique to determine a relative distance or position of the power lines. The EMR analysis technique 414 may be implemented using a relationship (e.g., a function, a lookup table, an equation, an interpolation or extrapolation technique, a curve, etc.) that corelates EMR magnitude with distance such that the EMR analysis technique 414 can identify a relative distance between the power lines and each of the EMR detectors 402.

The LiDAR analysis technique 416 may be configured to use a time of flight technique to determine, based on the LiDAR data, a relative distance or positioning of the object or obstacle above the refuse vehicle 10. For example, the LiDAR sensors 406 may emit light in an upwards direction at a first time, and receive reflected light at a second time. The LiDAR analysis 416 may be configured to use multiple time of flight data (e.g., the difference between the first time and the second time) from each of a plurality of light emitting paths of the LiDAR sensors 406 and determine a relative distance and geometry of the object or obstacle that is above the refuse vehicle 10.

The object detection manager 410 is configured to output the obstacle type and the relative distance or position of the obstacle to a profile manager 418. The profile manager 418 may also receive GPS data from the GPS system 124. The profile manager 418 is configured to use the obstacle type and relative distance or position of the obstacle in combination with the GPS data in order to determine obstacle profiles (e.g., obstacle maps) for a location (e.g., a pickup area). The profile manager 418 may generate the profile including an identification of which objects or obstacles are present, what location the objects or obstacles are present at, and their relative distances or positions. The profile manager 418 may also identify, based on the obstacle type and distance, one or more locations (e.g., latitude and longitude locations) at which the lift apparatus 116 can be operated (e.g., lift locations). The lift locations can be included in the profile. The profile manager 418 is configured to provide the profile to a profile database 420 for retrieval by the refuse vehicle 10 (e.g., a controller of the refuse vehicle 10) or other refuse vehicles 10 when at the location (e.g., the pickup area, a customer site, etc.). In some embodiments, the lift locations are determined by the profile manager 418 automatically when results of the object detection manager 410 are first obtained at a jobsite. The lift or pickup locations may also be defined and set up initially by a highly skilled operator when the customer is added to a route. For example, the highly skilled operator may go to the customer location and using a handheld GPS device or smartphone, define a specific location where the lift apparatus 116 can be operated without any overhead obstacles within the threshold distance. In some embodiments, the profiles and the lift or pickup location is initially defined by obtaining scan data at the customer location using a scan device. For example, a technician may go to the customer location equipped with a handheld or mobile scan device (e.g., a wheeled unit including cameras 404, EMR detectors 402, LiDAR detectors 406, etc.) and obtain the image data, the EMR data, and the LiDAR data for processing by the object detection manager 410 to determine the profile and identify obstacles.

In some embodiments, the profile manager 418 is configured to use a retrieved profile when the GPS data indicates that the refuse vehicle 10 has arrived at the location. The profile of the location can be retrieved from the database 420 which includes multiple profiles each corresponding to different locations, jobsites, pickup areas, etc. The profile may be an object or obstacle detection map indicating size, positions, and types of different obstacles or objects at the location. The profile manager 418 may compare currently detected objects or obstacles at the current GPS location (indicated by the GPS data) to the objects or obstacles in the profile for the corresponding location. If the currently detected objects or obstacles (or lack of detection of objects or obstacles) does not match the objects or obstacles indicated by the profile retrieved from the profile database 420, the profile manager 418 may determine that the objects or obstacles at the location have changed. For example, if a tree branch is previously detected and indicated by the profile but later cut down by an owner of the location, the profile manager 418 may identify, based on the comparison between the results of the objection detection manager 410 and the profile, updates or adjustments to the profile to account for the removed branch.

Similarly, if a tree or other obstacle is newly present at the location, the profile manager 418 may determine, based on the comparison between the results of the object detection manager 410 and the profile, that the profile should be updated to include the newly present obstacle at the location. In this way, the continual detection provided by the awareness system 400 can be used to build up and adjust profiles in the profile database 420. In some embodiments, the profile manager 418 is configured to use the result of the object detection manager 410 to augment or adjust the GPS location of the vehicle 10 (e.g., to operate autonomously at the location based on both the known obstacle map and the GPS data).

In some embodiments, the profiles stored in the profile database 420 also include an identified or recommended pickup or lift location for the refuse vehicle 10. The pickup or lift location may indicate a particular location or spot (e.g., a GPS location) at which the lift apparatus 116 should be operated. The pickup or lift location may be a location that is known to not have overhead obstacles that would impede operation of the lift apparatus 116. In some embodiments, the profile manager 418 is configured to provide the recommended pickup location and obstacle data (e.g., of both the profile and the current results of the object detection manager 410) to a control manager 422.

Referring still to FIG. 9, the memory 436 further includes the control manager 422 and a display manager 424. The control manager 422 is configured to use outputs of the profile manager 418 (e.g., the results of the object detection manager 410) in order to implement autonomous operation of the vehicle 10. The control manager 422 is configured to receive the recommended pickup or lift location of the profile from the profile manager 418 as well as the obstacle data from the profile manager 418 (e.g., the obstacle data of the profile of the profile database 420 and as currently detected by the awareness system 400). The control manager 422 is also configured to receive the GPS data from the GPS system 124.

The control manager 422 can generate lift signals for the lift apparatus 116 and control signals for the driveline 110, the braking system 112, and the steering system 114. The control manager 422 may generate the lift signals in order to cause or allow operation of the lift apparatus 116 or to limit (e.g., prevent, restrict, lock, etc.), operation of the lift apparatus 116. In some embodiments, the control manager 422 limits operation of the lift apparatus 116 in response to either (a) the awareness system 400 detecting that an obstacle is above the vehicle 10 within a threshold distance, or (b) detection that the refuse vehicle 10 is not currently located at the pickup or lift location. In some embodiments, if the control manager 422 identifies that the awareness system 400 is detecting an obstacle above the vehicle 10 within the threshold distance (e.g., a distance required to provide sufficient clearance to operate the lift apparatus 116), the control manager 422 operates the driveline 110, the braking system 112, and the steering system 114 to autonomously transport the vehicle 10 to a location at which obstacles or objects are not overhead the vehicle 10 within the threshold distance. In some embodiments, the control manager 422 is configured to operate the driveline 110, the braking system 112, and the steering system 114 to autonomously transport the vehicle 10 to the pickup or lift location in response to determining that the vehicle 10 is not currently at the pickup or lift location. The control manager 422 can use real-time feedback of the GPS data in order to autonomously transport the vehicle 10 to the lift or pickup location.

Once the control manager 422 identifies that the vehicle 10 is at the pickup or lift location, or alternatively, that no obstacles are detected by the awareness system 400 within the threshold distance, the control manager 422 can operate the lift apparatus 116. In this way, the control manager 422 controls operation of the lift apparatus 116 to limit or allow lifting operations to ensure that the lifting operations of the lift apparatus 116 are only performed when sufficient overhead clearance is available above the vehicle 10 (e.g., when no obstacles such as power lines, tree branches, fire escapes, etc., are above the vehicle 10 within the threshold distance).

The display manager 424 is configured generate a graphical user interface (“GUI”) for an operator or user of the vehicle 10 based on the results of the object detection manager 410. The display manager 424 is configured to obtain the results of the object detection manager 410 and produce graphical displays of any obstacles that are detected. In some embodiments, the display manager 424 is configured to receive display data of the corresponding or detected obstacles from the profile manager 418. The display manager 424 is configured to generate an overlaid GUI and provide the overlaid GUI to a user interface 136 (e.g., a display screen, a touch screen, etc.). The overlaid GUI may include ghost or phantom images of the obstacles detected by the object detection manager 410 superimposed over image data of a surrounding area of the vehicle 10. The overlaid GUI may also include an indication (e.g., a ghosted, phantom, transparent, etc.) model of the vehicle 10 at the pickup or lift location in order to guide an operator to the pickup or lift location. The user interface 136 may be positioned locally at the refuse vehicle 10 or may be at a remote location (e.g., at an operator or technician center for fleet management purposes).

Referring still to FIG. 9, it should be understood that any of the functionality of the controller 430 may be implemented on the controller 102 of each of a fleet of refuse vehicles 10. In some embodiments, one or more functions of the controller 430 are implemented by the controller 102 and one or more functions of the controller 430 are implemented by the remote computing system 134 with which the controller 102 is in communication. In one example, the remote computing system 134 includes the profile database 420 and is configured to provide requested profiles to the controller 102 which implements the functionality of the object detection manager 410, the profile manager 418, the control manager 422, and the display manager 424. In another example, the remote computing system 134 is configured to implement all of the functionality of the controller 430 except the obtaining of the image data, the EMR data, and the LiDAR data. The controller 102 may be responsible for obtaining, from the cameras 404, the EMR detectors 402, and the LiDAR detectors 406, the image data, the EMR data, and the LiDAR data, which are forwarded (e.g., via the telematics unit 132) to the remote computing system 134 which implements the functionality of the controller 430 as shown. The remote computing system 134 may provide the controller 102 with the lift signals and the control signals such that the controller 102 can operate the lift apparatus 116, the driveline 110, the braking system 112, and the steering system 114. Accordingly, any of the functionality of the controller 430 may be performed in a distributed manner between the controller 102 and the remote computing system 134.

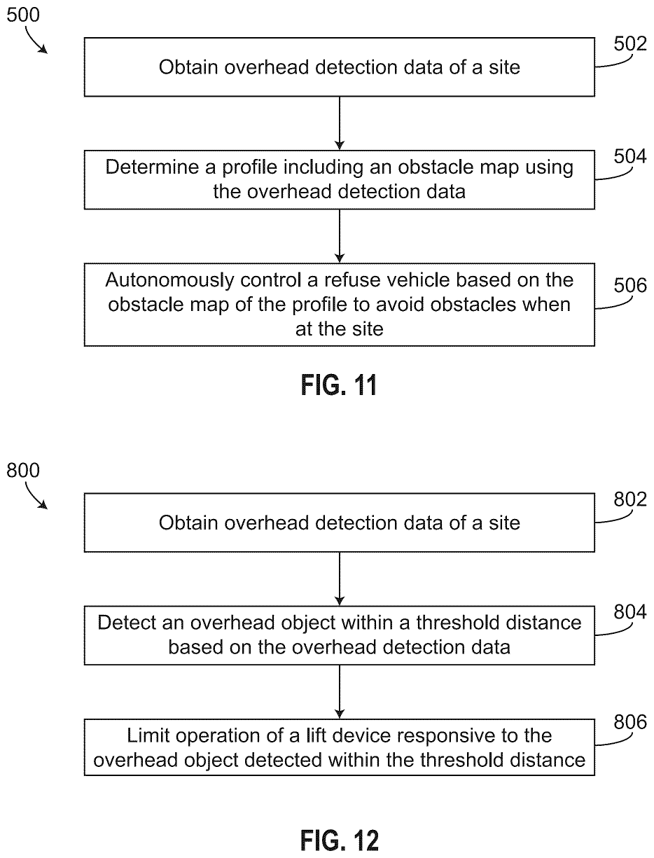

Referring to FIG. 11, a process 500 (e.g., a method) of autonomously operating a refuse vehicle to avoid overhead obstacles within a threshold distance includes steps 502-506. The process 500 may be implemented at the controller 102 and the remote computing system 134 based on data obtained by the awareness system 400 or other data source.

The process 500 includes obtaining overhead detection data of a site (step 502), according to some embodiments. The overhead detection data of the site may include image data, LiDAR data, EMR detection data, etc. The overhead detection data may be obtained by a mobile or wheeled detection unit, a handheld measuring unit, etc., of a technician when first visiting the site, prior to arrival of a refuse vehicle. The overhead detection data may also be obtained by the awareness system 400 of the refuse vehicle 10 when first arriving at the site (e.g., while being operated by a highly skilled operator). The overhead detection data may indicate overhead obstacles, distance of the overhead obstacles (e.g., position relative to a ground surface or relative to a top of a refuse vehicle), and types of obstacles (e.g., power lines, tree branches, fire escapes, etc.).

The process 500 includes determining a profile including an obstacle map using the overhead detection data (step 504), according to some embodiments. The step 504 may be implemented by the controller 102, the controller 430, or the remote computing system 134 by implementing the functions of the profile manager 418. The profile can include types, positions, and distances of the obstacles in the obstacle map as well as corresponding visual or graphical representations of the obstacles. The profile can also include an identified pickup or lift location at which it is determined that sufficient overhead clearance is available to operate a lift apparatus of the refuse vehicle. The profile may be stored in the profile database 420.

The process 500 includes autonomously controlling a refuse vehicle based on the obstacle map of the profile to avoid obstacles when at the site (step 506), according to some embodiments. The step 506 may include retrieving the profile corresponding to the site when the refuse vehicle approaches the site for refuse collection. The step 506 can be implemented by the controller 102 by autonomously transporting the refuse vehicle to a pickup or lift location. The step 506 can also include limiting operation of the lift apparatus 116 until the refuse vehicle has transported to a location at which sufficient overhead clearance is available to operate the lift apparatus 116 (e.g., away from the obstacles indicated by the obstacle map, to the identified pickup or lift location, etc.).

Referring to FIG. 12, a process 800 (e.g., a method) of operating a refuse vehicle based on real-time obstacle detection data includes steps 802-806. The process 800 can be performed by the controller 102 using real-time feedback from the awareness system 400. The process 800 can be implemented in order to limit operation of the lift apparatus 116 until sufficient overhead clearance is available at a current position of the refuse vehicle 10.

The process 800 includes obtaining overhead detection data of a site (step 802), according to some embodiments. The step 802 may be similar to the step 502 of the process 500. The step 802 can include obtaining the feedback from the cameras 404, the EMR detectors 402, and the LiDAR detectors 406 that are configured to identify obstacles overhead the refuse vehicle 10.

The process 800 includes detecting an overhead object within a threshold distance based on the overhead detection data (step 804), according to some embodiments. The step 804 may be performed by the controller 102 or the controller 430 by implementing the functionality of the object detection manager 410. The step 804 may include performing an image analysis technique based on image data obtained from the cameras 404, a time of flight technique based on the LiDAR data obtained from the LiDAR detectors 406, and EMR analysis based on the EMR data obtained from the EMR detectors 402. The step 804 can include identifying both a type of the object, as well as a distance from a top of the refuse vehicle 10 or other part of the refuse vehicle 10.

The process 800 includes limiting operation of a lift device responsive to the overhead object detected being within the threshold distance (step 806), according to some embodiments. The step 806 may alternatively include allowing operation of the lift device (e.g., the lift apparatus 116, the lift assembly 40, etc.) if no obstacles are detected within the threshold distance. Advantageously, the process 800 can be implemented in order to limit operation of the lift device when overhead obstacles are present (e.g., power lines) and allow operation of the lift device when sufficient overhead clearance is available.

### Refuse Container Pocket Detection

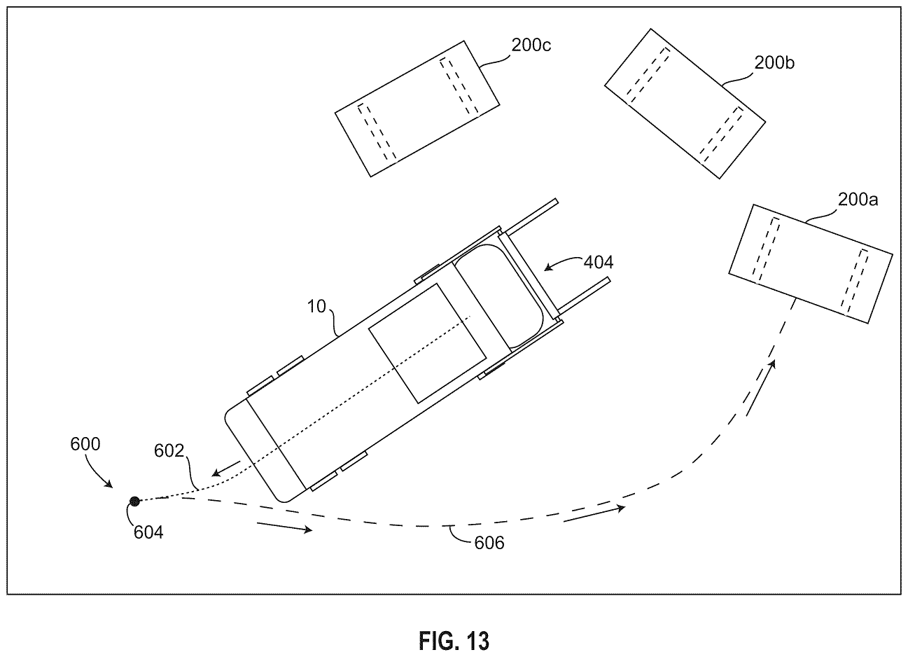

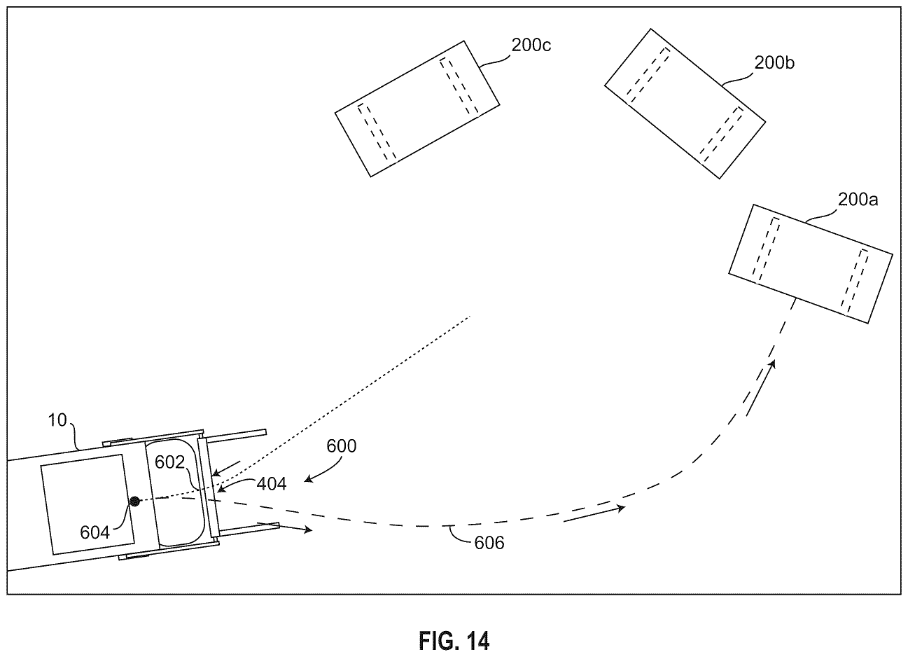

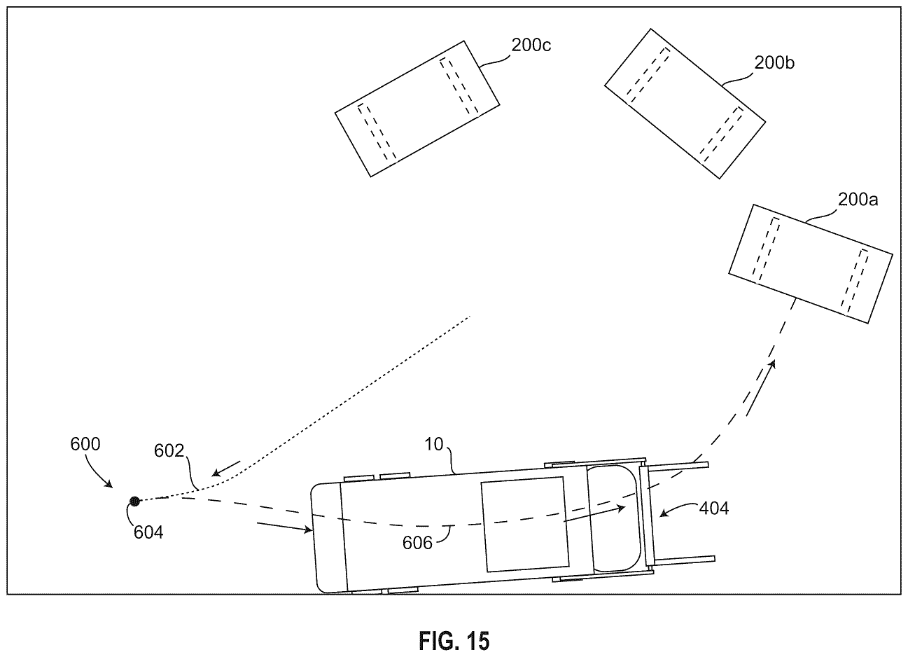

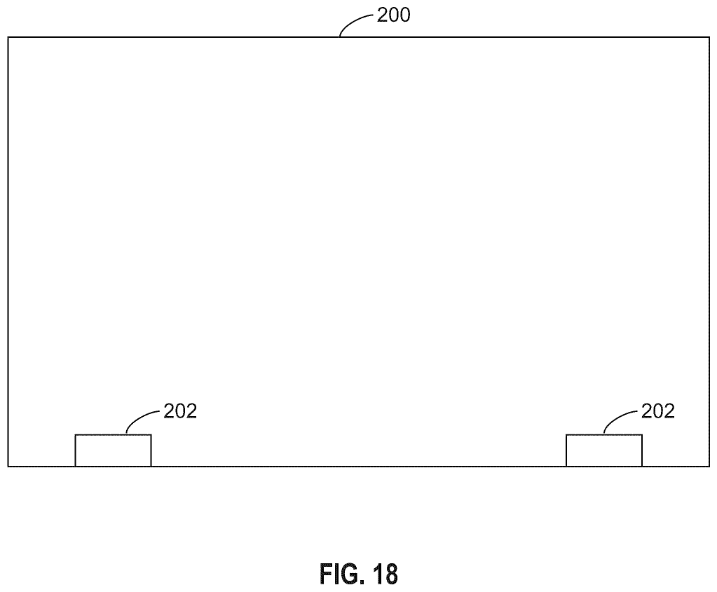

Referring to FIGS. 13-20, the awareness system 400 can be configured to identify a location of a refuse container 200 relative to the refuse vehicle 10 and determine an optimal path of transportation of the refuse vehicle 10 in order to insert forks of the lift assembly 40 into pockets or recesses of the refuse container 200. The awareness system 400 can autonomously operate the refuse vehicle 10 to transport to the refuse container 200 or can operate a display screen to provide augmented reality or overlaid imagery of the route such that the operator of the refuse vehicle 10 can transport the vehicle 10 along the route to the refuse container 200.

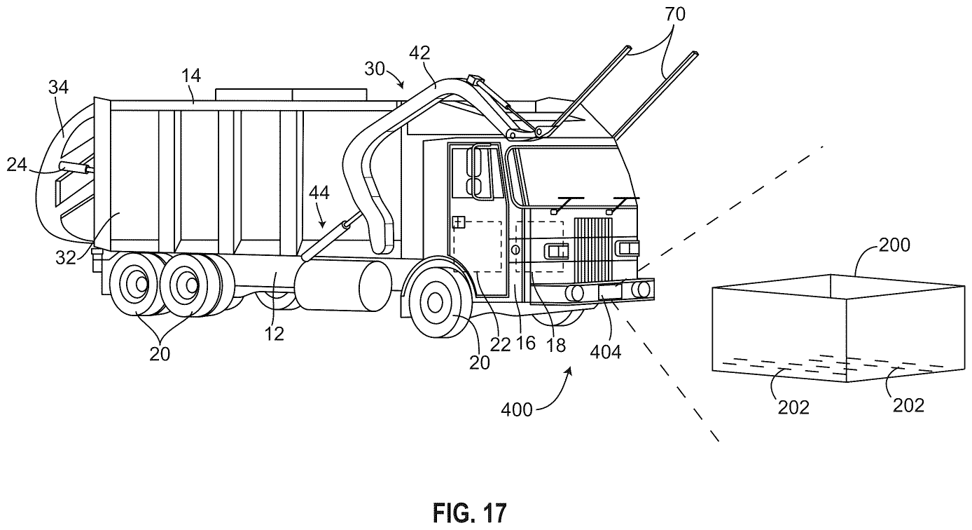

Referring particularly to FIG. 17, the awareness system 400 includes a camera 404 positioned on a front end of the refuse vehicle 10. The camera 404 is oriented in order to obtain image data of an area or zone in front of or around the refuse vehicle 10. For example, the awareness system 400 can include multiple cameras 404 oriented outwards about the refuse vehicle 10 (e.g., on the cab 16, on the body 14, etc.) in order to obtain image data of refuse containers 200 proximate the refuse vehicle 10. The image data may include indications of pockets 202 (e.g., recesses, slots, channels, receiving portions, etc.) of the refuse container 200. For example, if the refuse container 200 is facing the camera 404, the camera 404 may obtain image data indicating positions of the pockets 202.

Referring to FIGS. 19 and 13-16, the controller 430 may include a pocket detector 426, a route planner 428, the control manager 422, and the display manager 424. The pocket detector 426 is configured to obtain the image data from the camera(s) 404 and determine, based on the image data, a position of the refuse container 200 and locations of the pockets 202. For example, the pocket detector 426 may identify, using an image recognition technique (e.g., a neural network, a convolutional neural network, an artificial intelligence, machine learning, supervised machine learning or neural networks, etc.) locations of the refuse container 200, as well as orientation of the refuse container 200. If the pockets 202 are visible in the image data, the pocket detector 426 may directly detect or identify the pockets 202 in the image data. If the pockets 202 are not visible in the image data, the pocket detector 426 can use a library of standard refuse containers and identify, based on the image data of the refuse container 200, which of the library of standard refuse containers the refuse container 200 corresponds to. For example, the pocket detector 426 may use a standard container such as a container that complies with ANSI Z245.60 and infer, based on the detected orientation of the refuse container 200 in the image data, the locations of the pockets 202 of the refuse container 200 even if the pockets 202 are not visible in the image data.

The pocket detector 426 is configured to provide detected pocket locations to the route planner 428 in order to determine a transportation route from a current location of the refuse vehicle 10 to the refuse container 200 such that the forks 70 are inserted properly into the pockets 202. The pocket detector 426 may use known positions and distances of the forks 70, a turning radius of the refuse vehicle 10, size of the refuse vehicle 10, etc., to determine a route for the refuse vehicle 10 from the current location to the refuse container 200. The route determined and output by the route planner 428 may minimize requirements to switch into a reverse gear or a distance required for the refuse vehicle 10 to backup. The pocket detector 426 may implement any of the functionality as described in greater detail in U.S. application Ser. No. 16/758,834, filed Apr. 23, 2020, the entire disclosure of which is incorporated by reference herein. The pocket detector 426 may also implement any of the functionality as described in greater detail in U.S. application Ser. No. 17/189,740, filed Mar. 2, 2021, the entire disclosure of which is incorporated by reference herein. The awareness system 400 as described in the present application may implement any of the functionality of U.S. application Ser. No. 17/232,367, filed Apr. 16, 2021.

If multiple refuse containers 200 are present in the image data provided by the cameras 404, the pocket detector 426 may detect the presence of all of the refuse containers 200. The route planner 428 may determine a route or travel path for the refuse vehicle 10 from the current location to each of the refuse containers 200 in order to insert the forks 70 into the pockets 202. In some embodiments, the route planner 428 is configured to determine multiple routes or travel paths for the refuse vehicle 10 from the current location to a first of the refuse containers 200, then to a second of the refuse containers 200, etc. In this way, the routes or paths of travel for the refuse vehicle 10 may be independent (e.g., from the current location of the refuse vehicle 10 to each of the refuse containers 200) or may be dependent (e.g., subsequent routes or paths of travel for the refuse vehicle 10 depend on previously taken routes or paths of travel). In other words, the route planner 428 may determine a single route for each of the refuse containers 200 from a current location of the refuse vehicle 10 or may determine a series of routes or travel paths for the refuse vehicle 10 to collect each of the refuse containers 200. The user or operator may be presented with an overlaid GUI via the display screen 136 that indicates all of the detected refuse containers 200 and provide a selection (e.g., by tapping an icon or overlaid image corresponding to each of the refuse containers 200 on the user interface 136) in order to cause the route planner 428 to provide route data to the control manager 422 for the selected route or to cause the display manager 424 to provide an overlaid GUI including route or path visualization to the operator via the user interface 136 to guide transportation of the refuse vehicle 10 along the route. The route planner 428 is configured to use a current position and angle of the refuse vehicle 10 relative to the refuse container 200 or vice versa, and a turn radius of the refuse vehicle 10 to determine the route or travel path to the refuse container 200. The route planner 428 may also use different inputs such as from the object detection manager 410 in order to ensure that the route or travel path avoids obstacles.

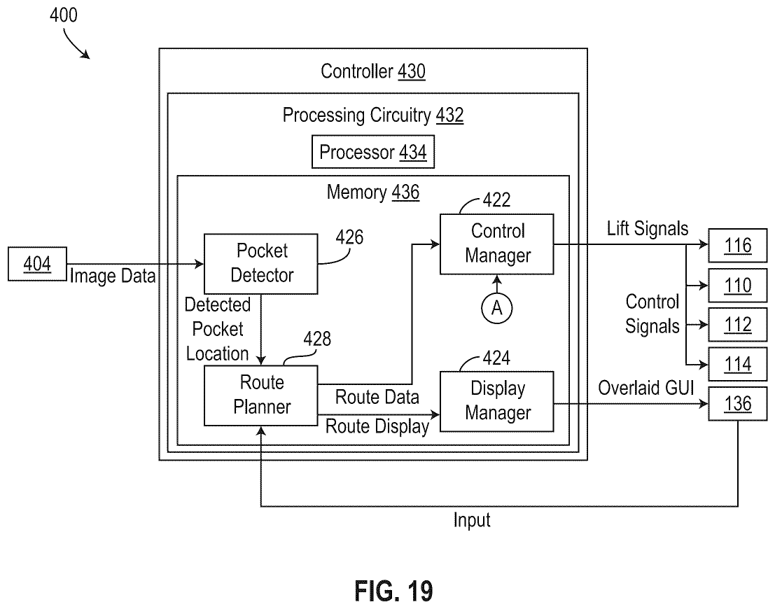

Referring still to FIG. 19, the control manager 422 is configured to receive the route data from the route planner 428 and operate the refuse vehicle 10 to transport along the route to the refuse container 200. In some embodiments, the control manager 422 is configured to generate lift signals for the lift apparatus 116 (e.g., the lift assembly 40) and control signals for the driveline 110, the braking system 112, and the steering system 114. In some embodiments, the control manager 422 is configured to autonomously operate the refuse vehicle 10 to transport to the refuse container 200 in response to receiving a user input to activate autonomous refuse collection (e.g., an activation of autonomous collection mode).

Referring still to FIG. 19, the display manager 424 is configured to receive route display data from the route planner 428 and operate the user interface 136 to provide a visual indication of the route to the selected refuse container 200 over image data that is displayed on the user interface 136. The overlaid GUI therefore provides real-time visual feedback to the operator of the refuse vehicle 10 such that the operator can transport the refuse vehicle 10 along the route that is displayed on the user interface 136. It should be understood that the controller 430 as described herein with reference to FIGS. 13-21 may also be configured to perform any of the functionality of the controller 430 described in greater detail above with reference to FIGS. 8-9. Similarly, any of the functionality of the controller 430 as described herein may be performed by the remote computing system 134.

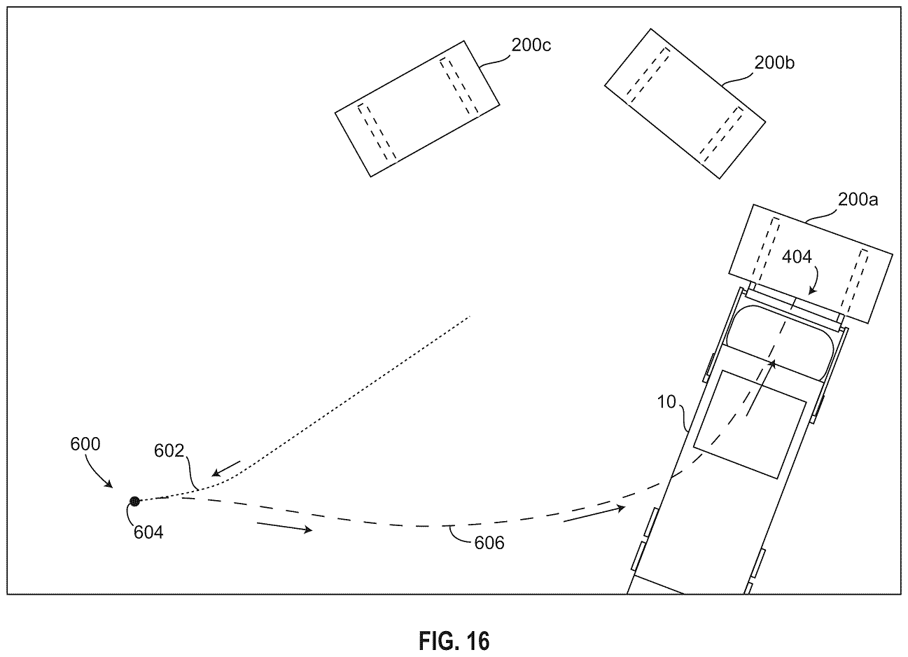

Referring particularly to FIGS. 13-16 and 19, the route planner 428 may determine a route 600 from a current location of the refuse vehicle 10 (e.g., as shown in FIG. 13) to a selected refuse container (e.g., a first refuse container 200a). FIGS. 13-16 also illustrate a second refuse container 200b and a third refuse container 200c which the route planner 428 may also determine routes for. The route 600 as shown includes a first portion 602 and a second portion 606. The first portion 602 illustrates a reverse path required to be taken. The second portion 606 illustrates a forwards path to be taken by the refuse vehicle 10. The path 600 also includes a transition point 604 at which point the refuse vehicle 10 is transferred from a reverse gear to a forwards or drive gear. The refuse vehicle 10 may be transported along the path 600 from the current location shown in FIG. 13 to the refuse container 200 such that the forks 70 are inserted into pockets 202 of the refuse container 200a (that is selected by the operator) as shown in FIG. 16. In some embodiments, the refuse vehicle 10 is configured to autonomously transport along the route 600 to the refuse container 200a. The route 600 may also be displayed by the user interface 136 in order to guide the operator to manually drive the refuse vehicle 10 to the refuse container 200a.

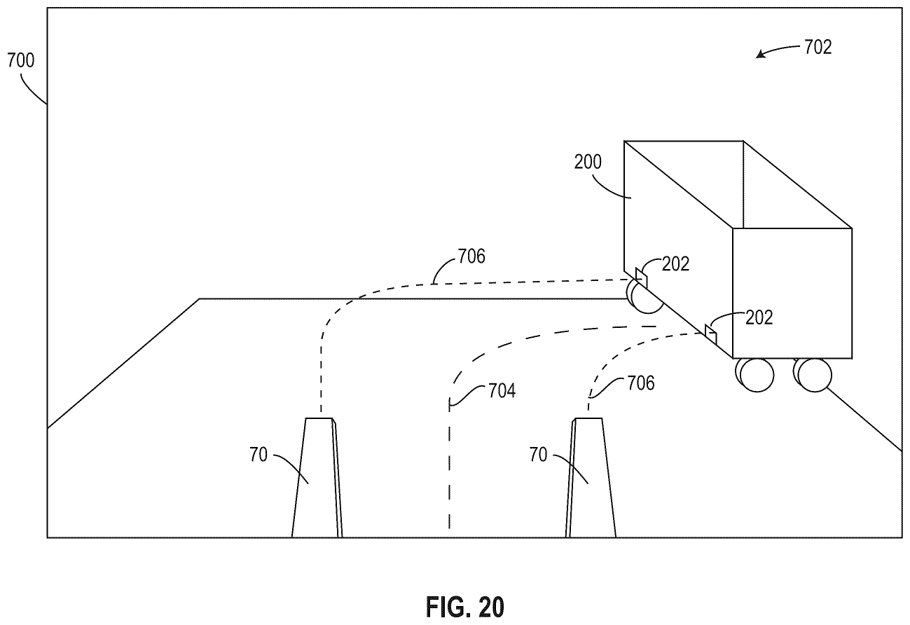

Referring to FIG. 20, a graphical user interface (GUI) 700 that can be generated by the display manager 424 and displayed on the user interface 136 includes image data 702 and route display data. The image data 702 may be image data obtained from a camera 404 at a front of the refuse vehicle 10. The route display data can include a refuse vehicle path 704 and fork path 706 visualizations that are superimposed over the image data 702 that is obtained from the camera 404 at the front of the refuse vehicle 10. The refuse vehicle path 704 and fork path 706 visualizations are shown guiding the refuse vehicle 10 to the refuse container 200 such that the forks 70 are received within the pockets 202. The operator may transport the vehicle 10 along the paths displayed in FIG. 20. In some embodiments, the user interface 136 on which the GUI 700 is displayed is integrated into a windshield of the refuse vehicle 10 such that the user interface 136 provides an augmented reality display of the refuse vehicle path 704 and the fork path 706 visualizations.

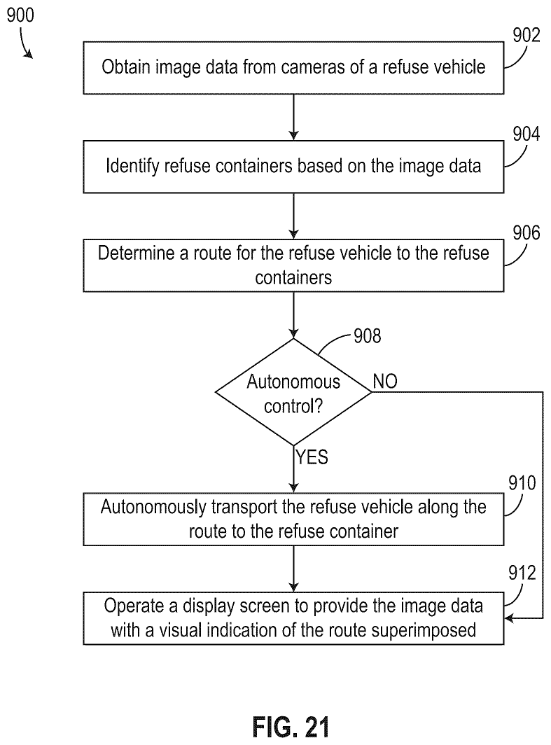

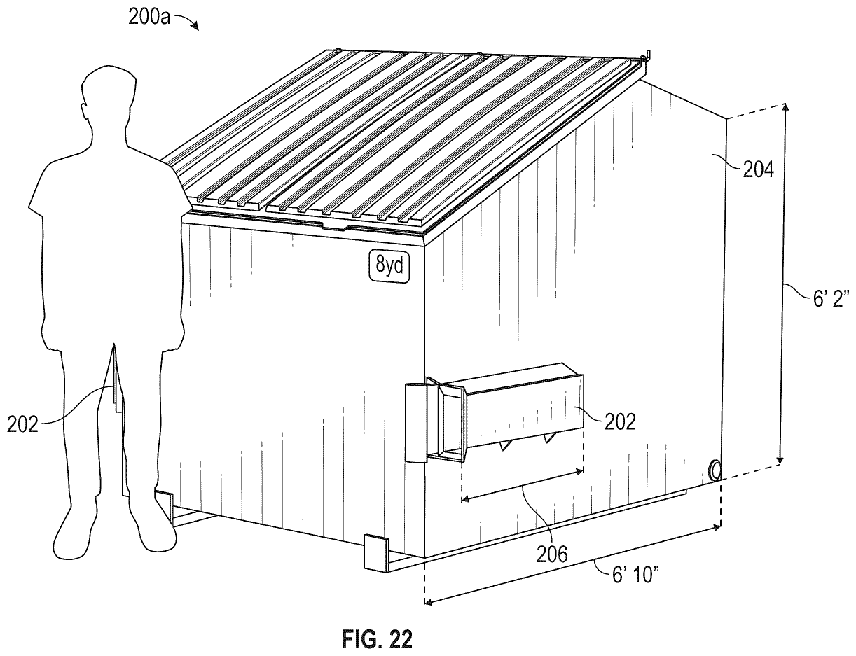

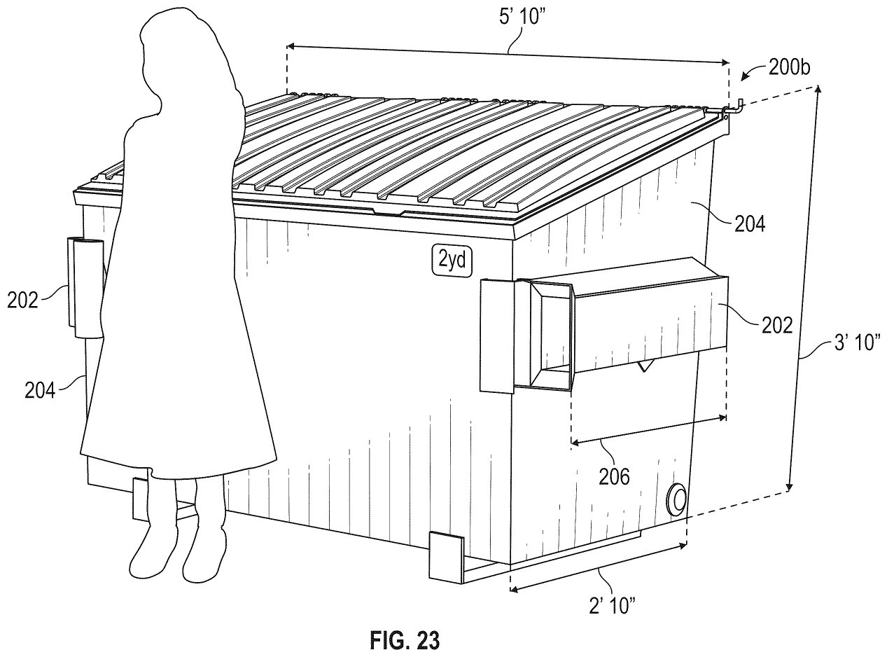

Referring to FIG. 21, a flow diagram of a process 900 for guiding a refuse vehicle to a refuse container includes steps 902-912. The process 900 can be performed by the awareness system 400, or more particularly, by the controller 430 of the awareness system 400. The process 900 may be implemented in order to detect the presence of refuse containers in a surrounding area of the refuse vehicle 10 and to autonomously transport the refuse vehicle 10 to the refuse containers, or to provide guidance to an operator of the refuse vehicle 10 to transport the refuse vehicle 10 to the refuse container.

The process 900 includes obtaining image data from cameras of a refuse vehicle (step 902), according to some embodiments. Step 902 can be performed by the controller 430 by obtaining the image data from the cameras 404. The image data may be externally or outwards facing cameras that are mounted about the refuse vehicle 10 (e.g., on the front of the refuse vehicle 10, on the rear of the refuse vehicle 10 as a backup camera, etc.) and configured to obtain image data of surrounding areas of the refuse vehicle 10. The image data may indicate the presence of one or more refuse containers that should be picked up and emptied into the hopper of the refuse vehicle 10.

The process 900 also includes identifying refuse containers based on the image data (step 904), according to some embodiments. Step 904 may be performed by the controller 430 by implementing the functionality of the pocket detector 426 (e.g., an image analysis technique, an image detection technique). Step 904 may include identifying an orientation and position of each of multiple refuse containers that are present in the image data. Step 904 can include identifying a position of pockets or recesses of the refuse containers for insertion of forks of the refuse vehicle.

The process 900 includes determining a route for the refuse vehicle to the refuse containers (step 906), according to some embodiments. In some embodiments, step 906 is performed by the controller 430 by implementing the functionality of the route planner 428 based on the results of step 904 (e.g., based on the results of the image recognition performed on the image data). The route may be determined or planned in step 606 such that the forks of the refuse vehicle are inserted properly into the pockets of the refuse containers in a most efficient or optimal manner. The route may use a least amount of reversing of the refuse vehicle as possible. In some embodiments, step 906 is performed for a selected refuse container responsive to a selection of one the multiple refuse containers.

The process 900 includes identifying if autonomous control of the refuse vehicle is activated (step 908), according to some embodiments. Step 908 may be performed by the controller 430 based on a user input provided. For example, the operator of the refuse vehicle or a user may provide an input that autonomous refuse collection is activated (e.g., a mode is activated). Step 908 may include operating a display device to prompt the operator to either activate autonomous refuse collection or to bypass autonomous refuse collection.

In response to autonomous control being activated (step 908, “YES”), process 900 proceeds to step 910. In response to autonomous control not being activated, process 900 proceeds to step 912.

The process 900 includes autonomously transporting the refuse vehicle along the route to the refuse container (step 910), according to some embodiments. Step 910 can include generating controls for a driveline, braking system, the lift apparatus or lift device, a steering system, etc., of the refuse vehicle in order to transport the refuse vehicle to the refuse container such that the forks of the lift apparatus are inserted into the pockets of the refuse container. Step 910 can include performing a lifting and emptying operation of the lift apparatus once the refuse vehicle has fully inserted the forks into the pockets of the refuse container.

The process 900 includes operating a display screen to provide the image data with a visual indication of the route superimposed (step 912), according to some embodiments. Step 912 can be performed by the controller 430 by operating a display screen or an augmented reality dashboard. Step 912 may be performed simultaneously with step 910. In some embodiments, step 912 is performed without performing step 910 in order to provide the operator of the refuse vehicle with a recommended route to manually transport the refuse vehicle to the refuse container (e.g., if the autonomous control of the refuse vehicle is not activated).

Referring to FIGS. 22 and 23, the refuse containers 200 can have a variety of sizes. As shown in FIG. 22, the refuse container 200 can be provided as an eight-yard refuse container 200a. The refuse container 200a is configured to store eight yards of refuse (e.g., in volume). The refuse container 200a includes pockets 202 defined on opposite sides 204 of the refuse container 200a. The pockets 202 have a depth 206 that is less than an overall depth of the refuse container 200a. The pockets 202 are configured to receive the forks 70 to removably couple the refuse container 200a with the refuse vehicle 10 for unloading. The eight-yard refuse container 200a may have a height of six feet and two inches and a depth of six feet and ten inches.

As shown in FIG. 23, the refuse container 200 can be provided as a two-yard refuse container 200b. The refuse container 200b is configured to store two yards of refuse (e.g., in volume). The refuse container 200b similarly includes pockets 202 defined on the opposite sides 204 of the refuse container 200b. The pockets 204 have depth 206 that is substantially equal to the overall depth of the refuse container 200b. The two-yard refuse container 200b can have a height of three feet ten inches, a depth of two feet ten inches, and a length of five feet ten inches. It should be understood that the eight-yard refuse container 200a and the two-yard refuse container 200b are provided for illustrative purposes only and that variously other sized refuse containers can be provided.

Referring to FIGS. 13-23, the route planner 428 can determine the route data to the refuse container 200 based on the detected size of the refuse container 200. For example, the pocket detector 426 can determine if the refuse container 200 is the eight-yard refuse container 200a or the two-yard refuse container 200b based on the image data. The route planner 428 is configured to determine the route data such that the forks 70 are inserted a distance into the pockets 202. The route data can include a threshold distance that the refuse vehicle 10 should be from the refuse container 200 as the refuse vehicle 10 approaches the refuse container 200. The threshold distance can indicate a degree of insertion of the forks 70 into the pockets 202. The threshold distance can be determined based on the size of the refuse container 200. For example, the threshold distance for the refuse container 200a may be different than the threshold distance for the refuse container 200b. The pocket detector 426 can perform an image analysis technique to determine the size and model of the refuse containers 200 based on the image data and an associated threshold distance for each of the refuse containers 200.

Referring to FIGS. 11 and 22-23, the refuse container 200a or the refuse container 200b can be determined as part of the profile in step 504. For example, step 502 can include obtaining both overhead detection data and environmental detection data (e.g., image data) of the site. The environmental detection data can include image data of the refuse containers 200 that are present at the site. The route planner 428 can determine various routes for the refuse containers 200 based on the size and the configuration of the pockets 202 on the refuse containers 200.

Referring to FIGS. 12 and 22-23, the refuse container 200a or the refuse container 200b can be associated with various threshold distances of overhead objects. For example, the process 800 includes detecting an overhead object within a threshold distance (step 804) and limiting operation of the lift device responsive to the overhead object detected withing the threshold distance (step 806) so as to avoid a collision between the refuse container 200 and the overhead object. In some embodiments, the threshold distance which the lift device is limited from operating when an overhead obstacle is present may be adjusted based on the size of the refuse containers 200. For example, the eight-yard refuse container 200a may protrude further from the forks 70 and therefore may require a larger threshold distance in order to avoid contact with the overhead object. The eight-yard refuse container 200a may have an overall depth or height that is greater than the two-yard refuse container 200b and therefore requires more overhead clearance (e.g., a greater value of the threshold distance). Accordingly, the process 800 can also include determining the threshold distance of step 804 based on the detected or known size of the refuse containers 200. The threshold distance for each of the refuse containers 200 can be stored in the profile for the site (step 502 of process 500).

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle, comprising:
a lift apparatus comprising forks configured to be received within pockets of a refuse container and lift and empty contents of the refuse container into a hopper of the refuse vehicle;
an electromagnetic radiation (“EMR”) detector configured to detect a presence of a power line overhead of the refuse vehicle; and
processing circuitry configured to:
obtain feedback from the EMR detector;
determine, based on the feedback, whether the power line is present overhead of the refuse vehicle within a threshold distance above the refuse vehicle; and
prevent operation of the lift apparatus responsive to determining that the power line is present within the threshold distance above the refuse vehicle.

2. The refuse vehicle of claim 1, wherein the processing circuitry is configured to determine a relative distance between the power line and a top of the refuse vehicle based on an intensity of EMR detected by the EMR detector.

3. The refuse vehicle of claim 1, wherein the refuse vehicle further comprises:
a distance sensor disposed on a top of the refuse vehicle, the distance sensor configured to detect a relative distance of an obstacle that is overhead of the refuse vehicle;
wherein the processing circuitry is configured to prevent operation of the lift apparatus responsive to determining that the obstacle is within the threshold distance above the refuse vehicle.

4. The refuse vehicle of claim 1, wherein the refuse vehicle further comprises:
a camera disposed on a top of the refuse vehicle, the camera configured to detect a relative distance of an obstacle that is overhead of the refuse vehicle;
wherein the processing circuitry is configured to prevent operation of the lift apparatus responsive to determining that the obstacle is within the threshold distance above the refuse vehicle.

5. The refuse vehicle of claim 1, further comprising an EMR detector disposed on a lift arm of the lift apparatus, the EMR detector configured to detect a relative distance between the power line and the lift arm of the lift apparatus, wherein the processing circuitry is configured to limit further operation of the lift apparatus in response to detecting that the power line is within a threshold distance of the lift arm.

6. The refuse vehicle of claim 1, further comprising a distance sensor disposed on a lift arm of the lift apparatus, the distance sensor configured to detect a relative distance between an obstacle and the lift arm of the lift apparatus, wherein the processing circuitry is configured to limit further operation of the lift apparatus in response to detecting that the obstacle is within a threshold distance of the lift arm.

7. The refuse vehicle of claim 1, further comprising a camera disposed on a lift arm of the lift apparatus, the camera configured to detect a relative distance between an obstacle and the lift arm of the lift apparatus, wherein the processing circuitry is configured to limit further operation of the lift apparatus in response to detecting that the obstacle is within a threshold distance of the lift arm.

8. A refuse vehicle, comprising:
a lift apparatus comprising forks configured to be received within pockets of a refuse container and lift and empty contents of the refuse container into a hopper of the refuse vehicle;
an outwards facing camera configured to obtain image data of an area proximate the refuse vehicle; and
processing circuitry configured to:
detect, based on the image data, a presence, location, and orientation of a refuse container;
determine, based on the presence, location, and orientation of the refuse container, a path for transportation of the refuse vehicle such that transportation of the refuse vehicle along the path results in the forks of the lift apparatus being properly aligned with and inserted into the pockets of the refuse container; and
at least one of (i) autonomously operate the refuse vehicle to transport along the path, or (ii) operate a display screen to provide the image data with a visual indication of the path superimposed over the image data.

9. The refuse vehicle of claim 8, wherein the path for transportation of the refuse vehicle comprises a reverse path for the refuse vehicle, a forwards path for the refuse vehicle, and a transition between the reverse path and the forwards path, the transition between the reverse path and the forwards path indicating a point at which to transition a transmission of the refuse vehicle between a reverse gear and a forwards gear.

10. The refuse vehicle of claim 8, wherein the processing circuitry is configured to determine, based on the image data, a location of the pockets of the refuse container, the path determined based on the location of the pockets of the refuse container such that the forks of the lift apparatus are aligned with and inserted into the pockets as the refuse vehicle travels along the path towards the refuse container.

11. The refuse vehicle of claim 8, wherein the processing circuitry is configured to determine, based on the presence, location, and orientation of the refuse container, a location of the pockets of the refuse container, the path determined based on the location of the pockets of the refuse container such that the forks of the lift apparatus are aligned with and inserted into the pockets as the refuse vehicle travels along the path towards the refuse container.

12. The refuse vehicle of claim 8, wherein the path is determined from a current location of the refuse vehicle to the refuse container.

13. The refuse vehicle of claim 8, wherein the path is determined based on a current position and orientation of the refuse vehicle relative to the refuse container, a turning radius of the refuse vehicle, and a size of the refuse vehicle.

14. The refuse vehicle of claim 8, wherein the path is a first path of a plurality of paths, the processing circuitry configured to determine the plurality of paths based on detection of a plurality of refuse containers.

15. The refuse vehicle of claim 8, further comprising:
an electromagnetic radiation (“EMR”) detector configured to detect a presence of a power line overhead of the refuse vehicle;
wherein the processing circuitry is further configured to:
obtain feedback from the EMR detector;
determine, based on the feedback, whether the power line is present overhead of the refuse vehicle within a threshold distance above the refuse vehicle; and
prevent operation of the lift apparatus responsive to determining that the power line is present within the threshold distance above the refuse vehicle.

16. The refuse vehicle of claim 8, further comprising:
a distance sensor disposed on a top of the refuse vehicle, the distance sensor configured to detect a relative distance of an obstacle that is overhead of the refuse vehicle;
wherein the processing circuitry is configured to prevent operation of the lift apparatus responsive to determining that the obstacle is within the threshold distance above the refuse vehicle.

17. The refuse vehicle of claim 8, further comprising:
a camera disposed on a top of the refuse vehicle, the camera configured to detect a relative distance of an obstacle that is overhead of the refuse vehicle;
wherein the processing circuitry is configured to prevent operation of the lift apparatus responsive to determining that the obstacle is within the threshold distance above the refuse vehicle.

18. The refuse vehicle of claim 8, further comprising an EMR detector disposed on a lift arm of the lift apparatus, the EMR detector configured to detect a relative distance between a power line and the lift arm of the lift apparatus, wherein the processing circuitry is configured to limit further operation of the lift apparatus in response to detecting that the power line is within a threshold distance of the lift arm.

19. The refuse vehicle of claim 8, further comprising a distance sensor disposed on a lift arm of the lift apparatus, the distance sensor configured to detect a relative distance between an obstacle and the lift arm of the lift apparatus, wherein the processing circuitry is configured to limit further operation of the lift apparatus in response to detecting that the obstacle is within a threshold distance of the lift arm.

20. A method of controlling operation of a refuse vehicle, the method comprising:
obtaining sensor data of a site from a sensor;
determining a profile of the site including an obstacle map using the sensor data; and
autonomously control the refuse vehicle based on the obstacle map such that the refuse vehicle avoids obstacles while transporting and operating a lift apparatus at the site.
